(19) United States
(12) Patent Application Publication
(10) Pub. No.: US 2008/0290059 A1
(43) Pub. Date: Nov. 27, 2008

(54) Multi flavor beverage bottle

(76) Inventor: Zach Benbassat, Orlando, FL (US)

Correspondence Address: McKinney Law, LLC, 390 N. Orange Avenue, Suite 2300, Orlando, FL, 32801, US

(21) Appl. No.: 11/753,683

(22) Filed: May 25, 2007

(51) Int. Cl. B65D 1/04; F16K 17/40

(52) U.S. Cl. 215/6; 137/68.23

(57) ABSTRACT

A multi flavor beverage bottle comprises a plurality of flavor packets wherein each flavor packet has an outer layer and an inner layer forming a void therebetween. A lance is perpendicularly interposed between the outer layer and inner layer of each flavor packet wherein the lance further comprises a tapered end for piercing a sidewall of the beverage bottle when the lance is compressed. Webbing is secured between each flavor packet so that the inner layer of the plurality of flavor packets is contiguously secured, to the sidewall of the beverage bottle. Flavoring liquid is contained within each flavor packet so that upon piercing the sidewall of the beverage bottle the flavoring liquid is in fluid communication with the unfavored liquid of the beverage bottle and provides a flavor to the liquid contained therein.

### FIELD OF THE INVENTION

The present invention relates generally to flavored beverages, and more specifically to a multi flavor beverage bottle that allows a consumer to select a flavor for the beverage prior to consumption.

### DESCRIPTION OF THE PRIOR ART

Supermarkets and convenience stores advertise and sell various flavors of beverages. For example, orange, lemon, grape and cherry flavored beverages may occupy shelf space. However, it is desirable for a single generic unflavored beverage to have the ability of being flavored by the consumer after purchase. Accordingly, a store can supply a shelf with one type of unflavored beverage to save shelf space from unwanted products and meet demand and increase revenue.

There have been attempts to improve containers to allow flavor to be added by the user. By way of example, note U.S. Pat. No. 5,310,564 to Kimm, that discloses a beverage container having internal flavoring tubes. The tubes have perforations so that when selective pressure is applied from outside of the container the flavoring is released into the container. A shortcoming of this prior art is that it is a costly and complex process to manufacture the flavoring tubes within a container.

Another example is U.S. Pat. No. 7,017,735 to Carlson that discloses a beverage container cap that contains liquid flavoring. However, Carlson is not adaptable to contain several different flavors for selection by a consumer.

Notwithstanding the existence of such prior art beverage containers, there is a need for an improved beverage bottle that is capable of multi flavors and is adaptable to retrofit existing containers and/or manufacturing equipment so that it is inexpensive and relatively simple to implement.

It is, therefore, to the effective resolution of the aforementioned problems and shortcomings of the prior art that the present invention is directed.

However, in view of the prior art at the time the present invention was made, it was not obvious to those of ordinary skill in the pertinent art how the identified needs could be fulfilled.

### SUMMARY OF THE INVENTION

This invention is a multi flavor beverage bottle comprising a plurality of flavor packets wherein each flavor packet having an outer layer and an inner layer forming a void therebetween; a lance perpendicularly interposed between the outer layer and inner layer of each flavor packet wherein the lance further comprising a tapered end for piercing a sidewall of the beverage bottle when the lance is compressed; webbing secured between each flavor packet forming the beverage bottle so that the inner layer of the plurality of flavor packets is contiguously secured to the sidewall of the beverage bottle; and flavoring liquid contained within each flavor packet so that upon piercing the sidewall of the beverage bottle the flavoring liquid is in fluid communication with unflavored liquid contents of the beverage bottle.

The multi flavor beverage bottle is used with prior art plastic beverage containers in the preferred embodiment so that manufacturing cost increases to implement the present invention are minimized. However, in alternative embodiments the multi flavor beverage bottle is used with beverage containers of a wide variety of shapes and sizes. The multi flavor beverage bottle of the present invention contains a different type of flavoring liquid identified by a corresponding different color. For example, cherry flavor is red, grape flavor is purple, etc. The flavor packets are transparent so that a user can identify the type of flavoring liquid by a corresponding color. The flavor packets are also equidistantly spaced on the webbing around the bottle and typically three or four different flavors are provided.

However, in alternative embodiments, the number of flavor packets can be more or less without departing from the scope of the invention. The flavor packets can also be integrated as part of the structure of the beverage bottle thereby eliminating the need for the webbing and piercing means. Accordingly, by applying pressure to the flavor packet, it ruptures the sidewall of the beverage bottle and flows directly into the unflavored contents of the beverage bottle.

In the preferred embodiment, the lance further comprises an inlet port at a first end for filling the flavor packet with flavoring liquid from a flavoring source. An outlet aperture is disposed proximate to the tapered end of the lance so that a conduit is formed between the inlet port and the outlet aperture of the lance for filling the flavor packet. After filling the flavor packet, the inlet port is sealed.

A water-tight seal is provided between the flavor packet and the sidewall of the beverage bottle so that when the sidewall of the beverage bottle is pierced no liquid leaks from between the flavor packet and the bottle. In the preferred embodiment, the multi flavor packets are plastic shrink wrapped to the beverage bottle using prior art methods.

In addition, a perforated area is provided on the sidewall of the beverage bottle adjacent to each flavor packet so that piercing the bottle by the lance is facilitated. In an alternative embodiment, the flavoring liquid of each flavor packet is at a higher pressure than the contents of the beverage bottle to facilitate the flavoring liquid's disbursement into the bottle upon piercing the sidewall of the beverage bottle.

It is therefore an object of the present invention to provide for an improvement that overcomes the aforementioned inadequacies of the prior art and provides a significant contribution to the advancement of flavored beverage containers.

Both the foregoing general description and the following detailed description are explanatory and are not restrictive of the invention as claimed. The accompanying drawings, which are incorporated in and constitute part of the specification, illustrate embodiments of the present invention and together with the general description, serve to explain principles of the present invention.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF THE DRAWINGS

For a fuller understanding of the nature and objects of the invention, reference should be made to the following detailed description, taken in connection with the accompanying drawings, in which:

FIG. 1 is a perspective view of a multi flavor beverage bottle according to the preferred embodiment of the present invention;

FIG. 2 is a cross sectional view of a multi flavor beverage bottle according to the preferred embodiment of the present invention;

FIG. 3 is a cross sectional view of a flavor packet of an embodiment of the present invention;

FIG. 4 is a cross sectional view of a flavor packet piercing a sidewall of a beverage bottle according to the preferred embodiment of the present invention;

FIG. 5 is a cross sectional view of a flavor packet in fluid communication with the contents of a beverage bottle according to the preferred embodiment of the present invention;

FIG. 6 is a cross sectional view of a flavor packet of an alternative embodiment of the present invention;

FIG. 7 is a cross sectional view of a flavor packet piercing a sidewall of a beverage bottle according to an alternative embodiment of the present invention; and

FIG. 8 is a cross sectional view of a flavor packet in fluid communication with the contents of a beverage bottle according to an alternative embodiment of the present invention.

### DETAILED DESCRIPTION OF THE PREFERRED EMBODIMENT

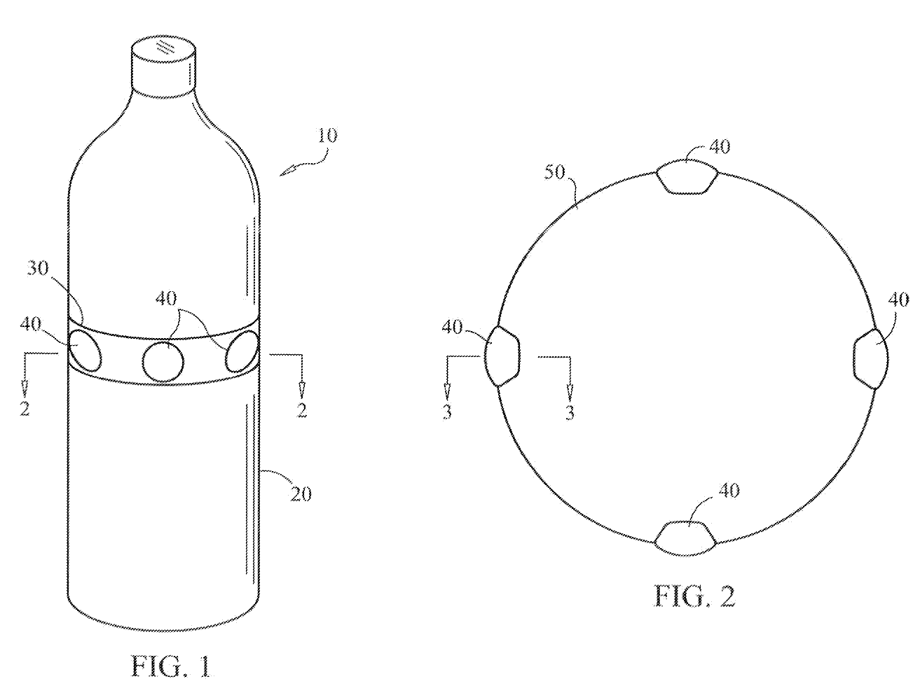

FIG. 1 shows the preferred embodiment of the multi flavor beverage bottle 10. The multi flavor beverage ring 30 is secured to a plastic beverage bottle sidewall 20. A flavor packet 40 is shown disposed on ring 30. In the preferred embodiment, ring 30 is secured to beverage bottle sidewall 20 around approximately the middle area. Accordingly, a user can grasp beverage bottle 10 below where beverage ring 30 is secured and use his/her thumb to press on flavor packet 40. A plurality of flavor packets 40 are dispersed on beverage ring 30 with each flavor packet 40 containing a different flavored liquid.

Referring now to FIG. 2 shows a cross sectional view of beverage ring 30 taken along section 2-2. Beverage bottle sidewall 20 is not shown in FIG. 2 for clarity of illustrating the structure of beverage ring 30. A semi-rigid webbing 50 encapsulates flavor packets 40 and also forms the shape of beverage ring 30.

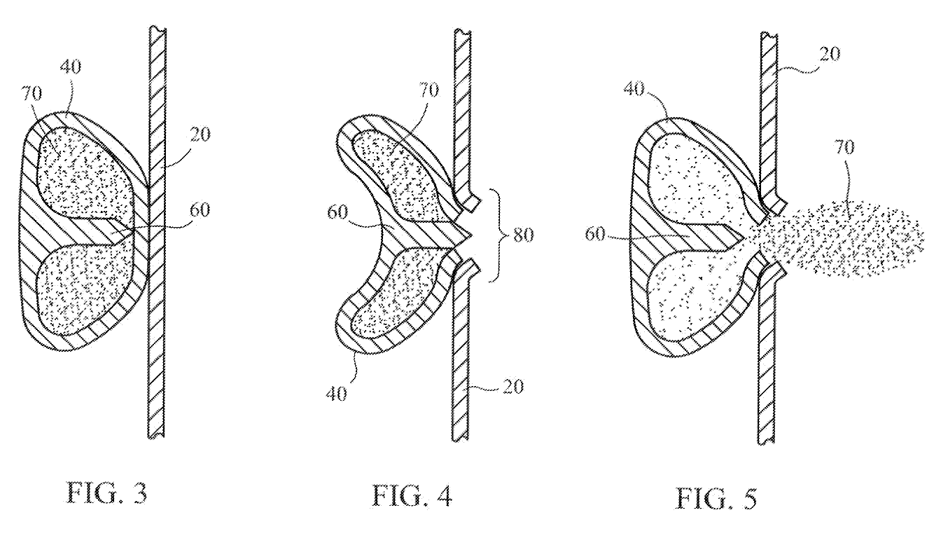

FIG. 3 shows flavor packet 40 adjacent to beverage bottle sidewall 20 taken along section 3-3. Lance 60 is perpendicular to sidewall 20 and is disposed approximately in the center of flavor packet 40. Flavoring liquid 70 is contained within flavor packet 40. Referring now to FIG. 4, flavor packet 40 has been compressed by user and forcing lance 60 through beverage bottle sidewall 20 forming an opening 80.

As shown in FIG. 5, once the beverage bottle sidewall 20 has been pierced, flavoring liquid 70 is in fluid communication with beverage bottle contents (e.g., unflavored water). As flavoring liquid 70 is dispersed within beverage bottle 10, the unflavored liquid bottle contents acquire the flavor of flavoring liquid 70. In the preferred embodiment, flavoring liquid 70 is a concentrate of sufficient proportion to the bottle contents to reach the desired dilation formula.

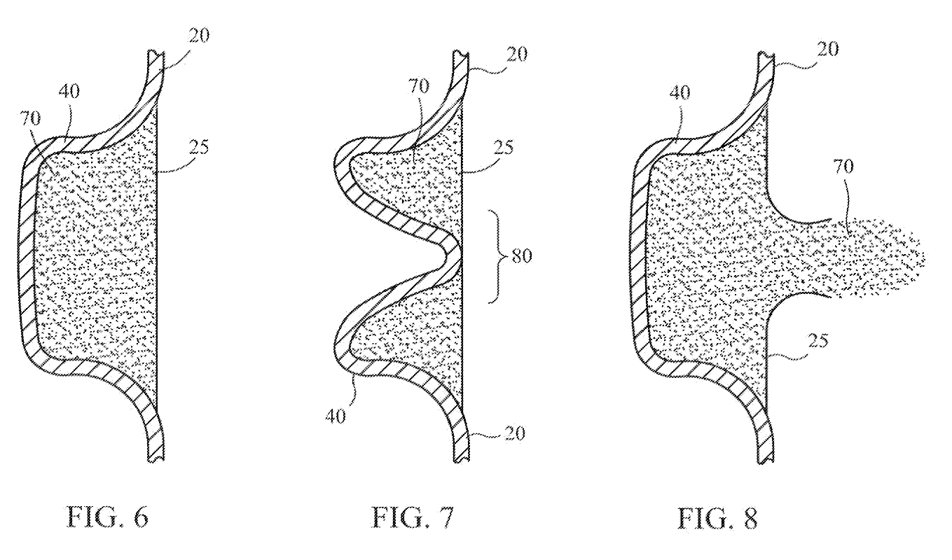

Referring now to FIG. 6 shows an alternative embodiment wherein flavor packet 40 is integrated into a beverage bottle sidewall 20. A perforated area 25 is formed in sidewall 20 underneath flavor packet 40. Similar to the preferred embodiment, flavoring liquid 70 is contained within flavor packet 40. Referring now to FIG. 7, flavor packet 40 has been compressed by user and forcing contact between an outer surface of flavor packet 40 and perforated area 25 at central location 80.

As shown in FIG. 8, perforated area 25 has been raptured by the application of external pressure by a user so that flavoring liquid 70 is in fluid communication with the beverage bottle contents (e.g., unfavored water). As flavoring liquid 70 is dispersed within beverage bottle 10, the unflavored liquid bottle contents acquire the flavor of flavoring liquid 70.

The particular embodiments disclosed above and in the drawings are illustrative only, as the invention may be modified and practiced in different but equivalent manners apparent to those skilled in the art having the benefit of the teachings herein. Furthermore, no limitations are intended to the details of construction or design herein shown. It is therefore evident that the particular embodiments disclosed above may be altered or modified and all such variations are considered within the scope and spirit of the invention.

It is also to be understood that the following claims are intended to cover all of the generic and specific matures of the invention herein described, and all statements of the scope of the invention, which as a matter of language, might be said to fall therebetween.

Now that the invention has been described,

What is claimed is:

1. A multi flavor beverage bottle comprising:
a plurality of flavor packets wherein each flavor packet having an outer layer and an inner layer forming a void therebetween;
a rigid lance perpendicularly interposed between said outer layer and inner layer of each said flavor packet wherein said lance further comprising a tapered end for piercing a sidewall of a beverage bottle when said lance is compressed;
webbing secured between each flavor packet forming a beverage flavoring ring so that said inner layer of said plurality of flavor packets is contiguously secured to said sidewall of said beverage bottle; and
flavoring liquid contained within each flavor packet so that upon piercing said sidewall of said beverage bottle said flavoring liquid is in fluid communication with unfavored contents of said beverage bottle.

2. The multi flavor beverage bottle of claim 1, wherein each flavor packet contains a different type of flavoring liquid identified by a corresponding different color.

3. The multi flavor beverage bottle of claim 1 wherein said bottle is a plastic beverage container.

4. The beverage flavoring ring of claim 1, wherein said lance further comprises an inlet port at a first end for filling said flavor packet with flavoring liquid from a flavoring source.

5. The lance of claim 4, wherein said lance further comprises an outlet aperture at a second end and within said void of said flavor packet so that a conduit is formed between said inlet port and said outlet aperture for filling said flavor packet.

6. The multi flavor beverage bottle of claim 1, further comprising a water-tight seal between said plurality of flavor packets and said sidewall of beverage bottle so that when said sidewall is pierced no liquid leaks from between said plurality of flavor packets and said beverage bottle.

7. The multi flavor beverage bottle of claim 3, further comprising a perforated area adjacent to each flavor packet so that piercing of said sidewall of beverage bottle by said lance is facilitated.

8. The multi flavor beverage bottle of claim 1, wherein said flavor packets are transparent so that a user can identify said type of flavoring liquid by a corresponding color.

9. The multi flavor beverage bottle of claim 1, wherein said flavoring liquid of each said flavor packet is at a higher pressure than said contents of said beverage bottle to facilitate said flavoring liquid disbursement into said beverage bottle upon piercing said sidewall of beverage container.

10. A multi flavor beverage bottle comprising:
a plurality of flavor packets integrated on an outer surface of said beverage bottle wherein each flavor packet having an outer layer and an inner layer forming a void therebetween;
a perforated area disposed on a sidewall of said beverage bottle adjacent to each flavor packet so that rupturing said sidewall of beverage bottle is facilitated upon application of external pressure;
flavoring liquid contained within each flavor packet so that upon rupturing said sidewall of said beverage bottle said flavoring liquid is in fluid communication with unflavored contents of said beverage bottle; and
each said flavor packet contains a different type of flavoring liquid identified by a corresponding different color.

11. A method of flavoring a beverage, the method comprising:
providing a beverage bottle;
providing a plurality of flavor packets wherein each flavor packet having an outer layer and an inner layer forming a void therebetween;
providing a rigid lance perpendicularly interposed between said outer layer and inner layer of each said flavor packet wherein said lance further comprising a tapered end for piercing a sidewall of said beverage bottle when said lance is compressed;
providing a webbing secured between each flavor packet forming a beverage flavoring ring so that said inner layer of said plurality of flavor packets is contiguously secured to said sidewall of said beverage bottle; and
providing a flavoring liquid contained within each flavor packet so that upon piercing said sidewall of beverage bottle said flavoring liquid is in fluid communication with said beverage bottle.

12. The method of claim 11, wherein each flavor packet contains a different type of flavoring liquid identified by a corresponding different color.

13. The method of claim 11, wherein said beverage bottle is a plastic beverage container.

14. The method of claim 11, further comprising providing said lance with an inlet port at a first end for filling said flavor packet with flavoring liquid from a flavoring source.

15. The method of claim 14, further comprising providing said lance with an outlet aperture at a second end and within said void of said flavor packet so that a conduit is formed between said inlet port and said outlet aperture for filling said flavor packet.

16. The method of claim 11, further comprising providing a water-tight seal between said plurality of flavor packets and said sidewall of beverage bottle so that when said sidewall is pierced no liquid leaks from between said plurality of flavor packets and said beverage bottle.

17. The method of claim 14, farther comprising providing a perforated area adjacent to each flavor packet so that piercing of said sidewall of beverage bottle by said lance is facilitated.

18. The method of claim 11, wherein said flavor packets are transparent so that a user can identify said type of flavoring liquid by a corresponding color.

19. The method of claim 11, wherein each said flavor packet of said plurality of flavor packets is equidistantly spaced on said webbing.

20. The method of claim 11, wherein said flavoring liquid of each said flavor packet is at a higher pressure than said contents of said beverage bottle to facilitate said flavoring liquid disbursement into said beverage bottle upon piercing said sidewall of beverage bottle.
